(19) United States
(12) Patent Application Publication
(10) Pub. No.: US 2019/0225202 A1
(43) Pub. Date: Jul. 25, 2019

(54) BRAKE PAD WEAR SENSOR

(71) Applicant: TRW AUTOMOTIVE U.S. LLC, Livonia, MI (US)

(72) Inventor: DAVID LEONARD JUZSWIK, Commerce TWP, MI (US)

(21) Appl. No.: 16/319,980

(22) PCT Filed: Jul. 25, 2017
(86) PCT No.: PCT/US17/43720

§ 371 Date: Jan. 23, 2019

Related U.S. Application Data
(60) Provisional application No. 62/368,208, filed on Jul. 29, 2016.

(51) Int. Cl. B60T 8/34; B60T 17/22; F16D 65/14; F16D 66/02

(52) U.S. Cl. CPC B60T 8/34; F16D 66/027; F16D 65/14; B60T 17/22

(57) ABSTRACT

A brake pad wear measuring system is for use a floating caliper disc brake system including a piston supporting an inner brake pad and a floating caliper supporting an outer brake pad, wherein the piston and floating caliper move toward each other along a braking axis in response to application of the brake system so that the brake pads engage and apply a braking force to a brake rotor. The brake pad wear system includes a sensor mounted on the floating caliper and movable with the floating caliper along the braking axis and an actuator mounted for movement with the piston along the braking axis. The sensor and actuator move toward each other in response to application of the disc brake system. The distance that the sensor and actuator move toward each other in response to application of the disc brake system increases an amount that is equal to the total wear of the inner and outer brake pads. The sensor is responsive to the presence of the actuator to provide a signal indicative of brake pad wear.

### RELATED APPLICATION

This application claims the benefit of U.S. Provisional Application Ser. No. 62/368,208, filed on Jul. 29, 2016, the disclosure of which is incorporated herein by reference in its entirety.

### TECHNICAL FIELD

The invention relates generally to brake pad wear sensing systems and devices. More particularly, the invention relates to a brake pad wear sensor that measures wear in both inner and outer brake pads of a disc braking system.

### BACKGROUND

It is desirable to sense and inform the driver when automotive brake pads need to be replaced. Known electronic brake wear sensors have a resistor circuit sensor that is cupped to the inner brake pad. As the pad is abraded away by the rotor, the sensor is also abraded away, changing its resistance. A pigtail harness is connected to the sensor which is wired to a sensing module in the vehicle.

There are several problems with the known approach. The multiple wire harnesses required and the additional sensing module makes this an expensive solution. Routing of the harnesses through the vehicle suspension and the wheel/steering knuckle area is very challenging and prone to road debris abuse. Additionally, the wear sensor has to be replaced each time the pads are replaced, which can be expensive.

While employing electronic sensors to detect brake pad wear, it is important to consider that the brake pad and brake caliper area can reach temperatures in excess of 300 degrees C., which many electronic sensors cannot withstand.

From a cost and implementation standpoint, it is desirable to not use any wire harness and to try to utilize existing product already on the vehicle to reduce the cost of transporting the pad wear information to the driver display. It is also desirable that it not be necessary to replace the brake pad wear sensor with the brake pads when they are replaced. It is also desirable that the brake pad wear sensor provides diagnostic (e.g., heartbeat) capabilities, and the sensor must be capable of withstanding the extreme temperatures seen during braking.

### SUMMARY

According to one aspect, a brake pad wear measuring system is for use a floating caliper disc brake system including a piston supporting an inner brake pad and a floating caliper supporting an outer brake pad, wherein the piston and floating caliper move toward each other along a braking axis in response to application of the brake system so that the brake pads engage and apply a braking force to a brake rotor. The brake pad wear system includes a sensor mounted on the floating caliper and movable with the floating caliper along the braking axis and an actuator mounted for movement with the piston along the braking axis. The sensor and actuator move toward each other in response to application of the disc brake system. The distance that the sensor and actuator move toward each other in response to application of the disc brake system increases an amount that is equal to the total wear of the inner and outer brake pads. The sensor is responsive to the presence of the actuator to provide a signal indicative of brake pad wear.

According to another aspect, the brake pad wear system can also include a controller that receives an output from the sensor and interprets the output to determine brake pad wear. The controller can determine the amount of brake pad wear in response to the output received from the sensor. The controller can also determine that the brake pads require servicing in response to the output received from the sensor.

According to another aspect, the sensor can include an inductive sensor and the actuator can be a metallic member. According to another aspect, the inductive sensor can produce a magnetic field, wherein eddy currents are induced in the actuator in response to the sensor and actuator moving toward each other in response to application of the disc brake system. The output of the inductive sensor can be proportional to the distance between the sensor and the actuator. The output of the inductive sensor can be indicative of the amount of wear on the brake pads. The output of the inductive sensor can indicate that the brake pads require servicing.

According to another aspect, the sensor can include a capacitive sensor and the actuator can be a metallic or nonmetallic member. The capacitive sensor can respond to the presence of the actuator and produce an output that indicates the brake pads require servicing. The output of the capacitive sensor can be proportional to the distance between the sensor and the actuator.

According to another aspect, the sensor can be a mechanical switch, and the actuator can actuate the switch in response to the application of the braking system, causing the sensor to produce an output that indicates the brake pads require servicing.

According to another aspect, the sensor can be a resistive element whose resistance varies in response to movement of the actuator in response to the application of the braking system. The resistive element can include a strain gauge arranged in a bridge circuit, wherein the actuator engages the sensor to place strain on the gauge in response to the application of the braking system, causing the sensor to produce an output indicative of brake pad wear.

According to another aspect, the sensor can be an optical sensor including a light emitter for transmitting a beam and a light receiver for receiving the beam. The actuator can at least partially block the light beam in response to the application of the braking system, causing the sensor to produce an output indicative of brake pad wear.

According to another aspect, the sensor can be a magnetic sensor that is sensitive to the presence of a magnetic field, and the actuator can be a permanent magnet. The actuator can produce a magnetic field that acts on the magnetic sensor in response to the application of the braking system, causing the sensor to produce an output indicative of brake pad wear.

According to another aspect, a brake system can include a floating caliper disc brake system comprising a piston supporting an inner brake pad and a floating caliper supporting an outer brake pad. The piston and floating caliper can move toward each other along a braking axis during braking so that the brake pads engage and apply a braking force to a brake rotor. A sensor can be mounted on the floating caliper and movable with the caliper along the braking axis. An actuator can be mounted for movement with the piston along the braking axis. The sensor and actuator can move toward each other in response to application of the disc brake system. The distance that the sensor and actuator move toward each other in response to application of the disc brake system increases an amount that is equal to the total wear of the inner and outer brake pads. The sensor is responsive to the presence of the actuator to provide a signal indicative of brake pad wear.

### BRIEF DESCRIPTION OF THE DRAWINGS

The foregoing and other features and advantages of the present invention will become apparent to those skilled in the art to which the present invention relates upon reading the following description with reference to the accompanying drawing, in which:

FIG. 1 is a schematic illustration of an example vehicle configuration showing disc brake components mounted on vehicle suspension components.

FIG. 2 is a schematic illustration depicting a brake wear sensor system implemented on an example disc brake configuration, wherein the disc brake is shown in a non-braking condition.

FIG. 3 is a schematic illustration depicting the brake wear sensor system of FIG. 2, wherein the disc brake is shown in a first braking condition with brake pads at a first level of wear.

FIG. 4 is a schematic illustration depicting the brake wear sensor system of FIG. 2, wherein the disc brake is shown in a second braking condition with brake pads at a second level of wear.

FIGS. 5A and 5B are schematic illustrations depicting one configuration of the brake wear sensor system.

FIG. 6 is a schematic illustration depicting another configuration of the brake wear sensor system.

### DETAILED DESCRIPTION

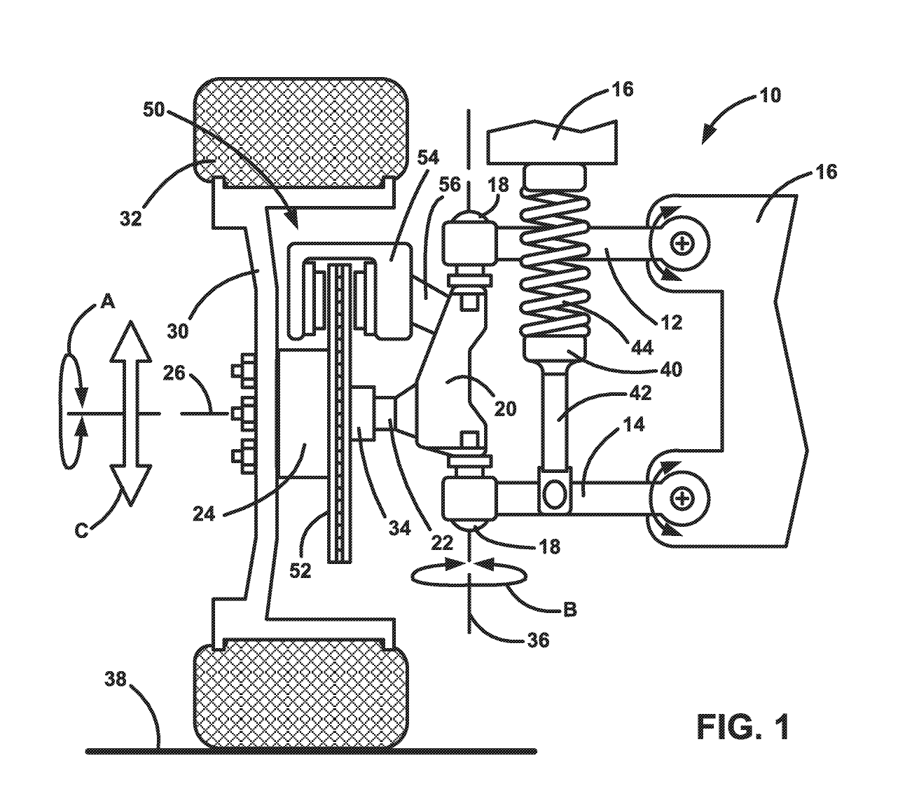

Referring to FIG. 1, an example vehicle suspension system 10 includes an upper control arm 12 and a lower control arm 14 that are connected to the vehicle 16 for pivoting movement. A steering knuckle 20 is connected to free ends of the control arms 12, 14 by ball joints or the like that permit relative movement between the knuckle and control arms. The steering knuckle 20 includes a spindle 22 that supports a wheel hub 24 for rotation (see arrow A) about a wheel axis 26. A wheel or rim 30 and tire 32 can be mounted on the wheel hub 24 by known means, such as lugs and lug nuts. The wheel hub 24 includes bearings 34 that facilitate rotation of the hub, rim 30, and tire 32 about the axis 26. The steering knuckle 20 is itself rotatable about a steering axis 36 (see arrow B) to steer the vehicle 16 in a known manner.

A damper 40, such as a shock absorber or strut, has a piston rod 42 connected to the lower control arm 14 and a cylinder 44 that is supported by structure of the vehicle 16, such as a vehicle frame-mounted bracket. The damper 40 dampens relative movement of the control arms 14, 16, and the steering knuckle 20 relative to the vehicle 16. The damper 40 can thus help dampen and absorb impacts between the road 38 and the tire 32, such as impacts with bumps, potholes, or road debris, that produce up and down movement (see arrow C) of the suspension system 10, the wheel 30, and the tire 32.

The vehicle 16 includes a disc braking system 50 that includes a brake disc 52 secured to the hub 24 for rotation with the hub, wheel 30, and tire 32. The disc braking system 50 also includes a brake caliper 54 that is secured to the steering knuckle 20 by a bracket 56. The disc 52 and the caliper 54 thus move in unison with the steering knuckle 20 through steering movements (arrow B) and suspension movements (arrow C). The disc 52 rotates (arrow A) relative to the caliper 54 and has an outer radial portion that passes through the caliper.

The configuration of the suspension system 10 shown in FIG. 1 is by way of example only and is not meant to limit the scope of the invention. The brake pad wear sensor system disclosed herein can be configured for utilization with any vehicle suspension configuration that implements disc brakes. For example, while the illustrated suspension system 10 is an independent front suspension, specifically an upper and lower control arm/A-arm (sometimes referred to as a double wishbone) suspension, other independent suspensions can be used. Examples of independent suspensions with which the brake pad wear sensing system can be implemented include, but are not limited to, swing axle suspensions, sliding pillar suspensions, MacPherson strut suspensions, Chapman strut suspensions, multi-link suspensions, semi-trailing arm suspensions, swinging arm suspensions, and leaf spring suspensions. Additionally, the brake pad wear sensing system can be implemented with dependent suspension systems including, but not limited to, Satchell link suspensions, Panhard rod suspensions, Watt's linkage suspensions, WOB link suspensions, Mumford linkage suspensions, and leaf spring suspensions. Furthermore, the brake pad wear sensing system can be implemented on front wheel disc brakes or rear wheel disc brakes.

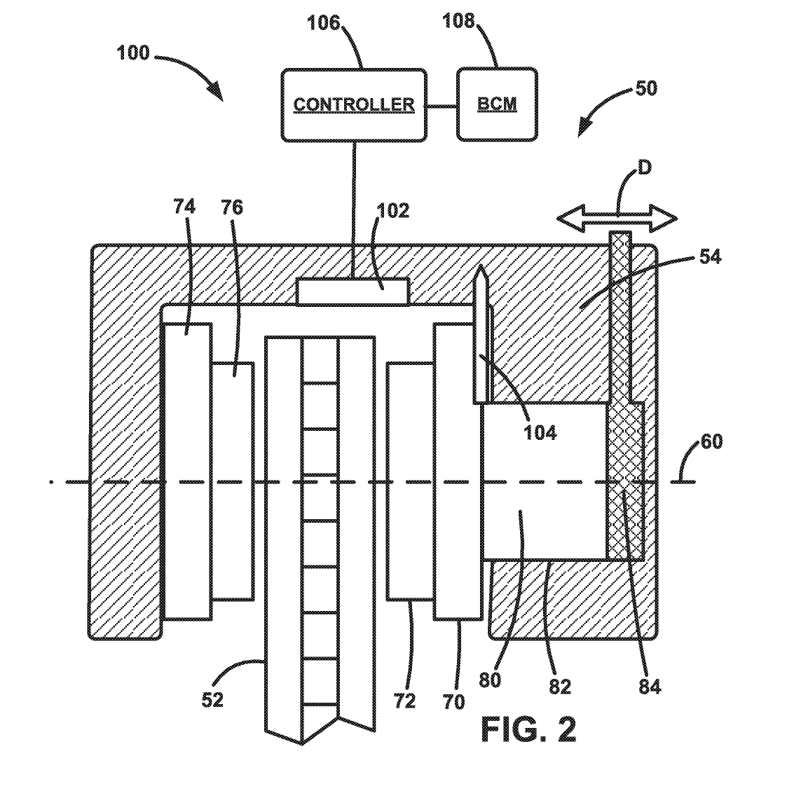

Referring to FIGS. 2-4, the disc braking system 50 is illustrated schematically and in greater detail. The brake system 50 is a single piston floating caliper system in which the connection of the caliper 54 to the vehicle 16 allows for axial movement of the caliper (“float”) relative to the brake disc 52. In this floating caliper configuration, the caliper 54 is permitted to move axially toward and away from the disc 52 (see arrow D) parallel to a braking axis 60.

The brake system 50 includes an inner brake pad holder 70 that supports an inner brake pad 72, and an outer brake pad holder 74 that supports an outer brake pad 76. The inner brake pad holder 70 is supported on a piston 80. The outer brake pad holder 74 is supported on the floating caliper 54. The piston 80 is disposed in a cylinder 82 that is supported on or formed in the floating caliper 54. Brake fluid 84 is pumped into the cylinder 82 in response to driver application of a brake pedal (not shown) in order to actuate the braking system 50.

The brake system 50 is maintained in the unactuated condition of FIG. 2 via bias applied by a biasing member (not shown), such as a spring. When the brake pedal is applied, the brake fluid 84 fills the cylinder 82 and applies fluid pressure to the piston 80, urging it to move to the left, as viewed in FIGS. 2-4. This causes the inner brake pad holder 70 and pad 72 to move along the braking axis 60 toward and the brake disc 52. The inner brake pad 72 engaging the disc 52 creates a reaction force that acts on the floating caliper 54, due to its supporting of the piston 80 and cylinder 82. Since the piston 80 is blocked against movement toward the disc 52 due to the engagement of the inner brake pad 72 with the disc, the brake fluid pressure in the cylinder 82 urges the floating caliper 54 to move to the right, as viewed in FIGS. 2-4. The floating caliper 54, moving to the right, causes the outer brake pad holder 74 and pad 76 to move along the braking axis 60 toward the brake disc 52. The inner pad 76 eventually engages the disc 52, which is now clamped between the inner and outer brake pads.

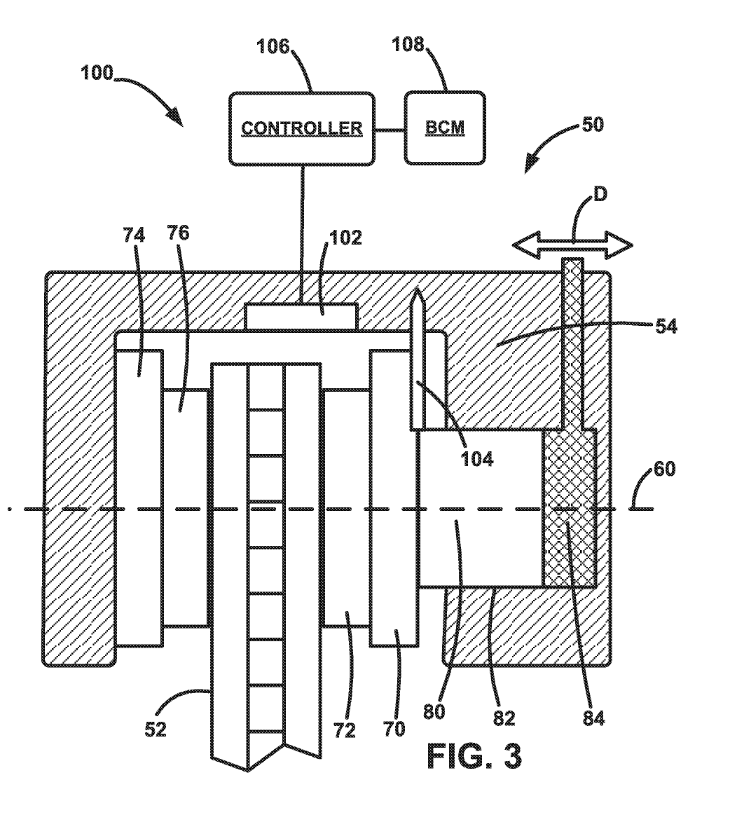

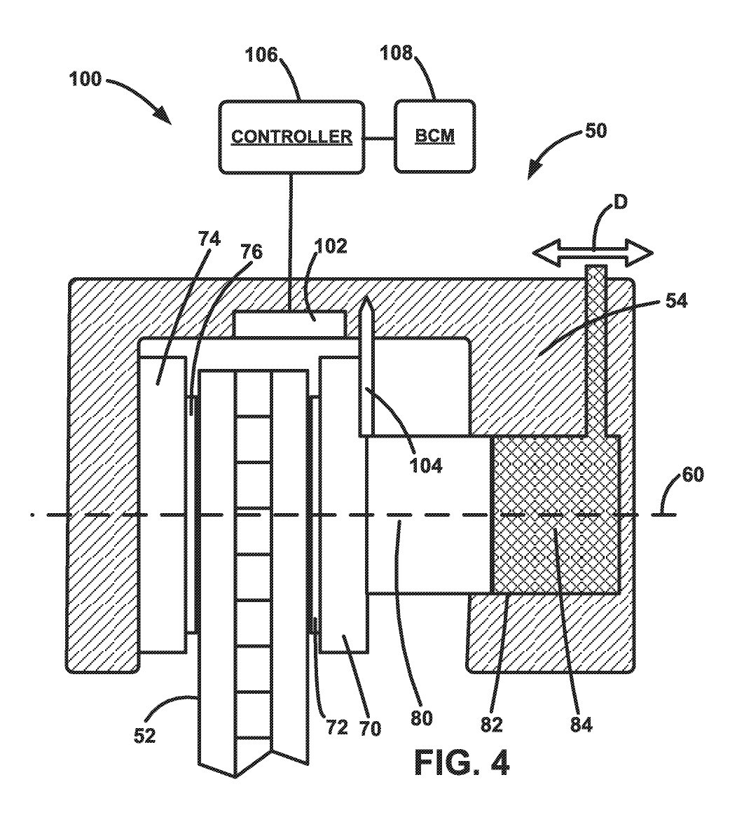

As the brake pads 72, 76 wear down, they become thinner. This is illustrated by comparing the brake pads 72, 76 of FIG. 3, which are fresh, thick, and unworn, to the brake pads of FIG. 4, which are old, thin, and worn-out. As seen in the comparison of FIGS. 3 and 4, owing to the floating caliper configuration of the brake system 50, both the piston 80 and the caliper 54 travel a greater distance when applying the worn pads of FIG. 4 than they do when applying the unworn pads.

A brake pad wear sensing system 100 measures the amount of wear in the brake pads 72, 76 without destroying any portion of the system. In this manner, there are no portions of the wear sensing system 100 that require replacement during routine maintenance and brake pad replacement. The wear sensing system 100 achieves this by measuring the travel distance of the brake caliper 54 and the piston 80 rather than the wear of the brake pads 72, 76 themselves. When new brake pads 72, 76 are installed, the components of the disc braking system 50, particularly, the caliper 54 and piston 80, return to their new pad positions (see FIG. 2). In this condition, the brake pad wear sensing system 100 senses the relative positions of the components and, based on this, determines that the brake pads 72, 76 are not in need of replacement. As the new pads wear, the caliper 54 and piston 80 necessarily travel further to apply braking forces until it reaches the point (see FIG. 4) where the sensing system 100 determines from the relative positions of the caliper and piston that pad replacement is required.

The brake pad wear sensor system 100 includes a sensor 102 and an actuator 104. The sensor 102 is mounted on the floating caliper 54 of the braking system 50. The actuator 104 is mounted on the piston 80 of the braking system 50, either to the piston itself, or the inner brake pad holder 70. The sensor 102 is operatively connected, either by wire or wirelessly, to a vehicle based controller 106. In one particular configuration, the controller 106 can be implemented in or along with a vehicle anti-lock braking system (ABS) controller. This can be convenient because the ABS system, employing tire rotation sensors, already requires that cables/wiring be routed to the area, which the brake pad wear sensing system 100 can take advantage of. Implementing the controller 106 in/along with the ABS controller is also convenient since it communicates with a main vehicle controller 108, such as a vehicle body control module (BCM). In this manner, the brake pad wear indications sensed by the system 100 can be transmitted to the BCM 108 via the controller 106, which can provide the relevant alerts/indications to the vehicle operator, for example, via the instrument panel/gauge cluster.

The sensor 102, being mounted on the floating caliper 54, moves with the caliper during application of the braking system 50. During brake application, the floating caliper 54 and the sensor 102 move to the right as viewed in FIGS. 2-4. The actuator 104, being connected to the piston 80, moves with the piston during application of the braking system 50. During brake application, the piston 80 and the actuator 104 move to the left as viewed in FIGS. 2-4.

When the brake pads 72, 76 are new or unworn, the distances that the sensor 102 and actuator 104 travel during brake application is comparatively small. As the brake pads 72, 76 wear, the distance that the sensor 102 and actuator 104 travel during brake application increases. An increase in the distance that the sensor 102 travels is indicative of the wear on the outer brake pad 76. An increase in the distance that the actuator 104 travels is indicative of the wear on the inner brake pad 72. The relative positions of the sensor 102 and actuator 104 thus provide an indication of total wear of the inner and outer pads 72, 76.

The actuator 104 actuates the sensor 102 to produce a signal indicative of the position of the actuator relative to the sensor. This signal can be variable and therefore be indicative of an amount (e.g., percent) of wear on the brake pads 72, 76, or it can be a binary indication of whether or not the brakes are worn (yes/no, pads OK/pads Worn). To achieve this, the sensor 102 can employ a variety of different sensing technologies, such as electrical switching, resistive sensing, inductive sensing, optical sensing, magnetic sensing, and capacitive sensing.

### Inductive Sensor Implementation

Due to its not being influenced by dirt and corrosion and not requiring physical contact, inductive proximity sensing can be an ideal configuration for the brake pad wear sensing system 100. Inductive proximity sensing can be implemented as a binary indication, i.e., in an “yes/no” configuration, that provides a “time to replace” indication for the brake pads 72, 76. Inductive proximity sensing can also be implemented as a wear indicator, i.e., with a variable output configuration that can provide, for example, a “percent worn” indication, as well as a “time to replace” indication, for the brake pads 72, 76.

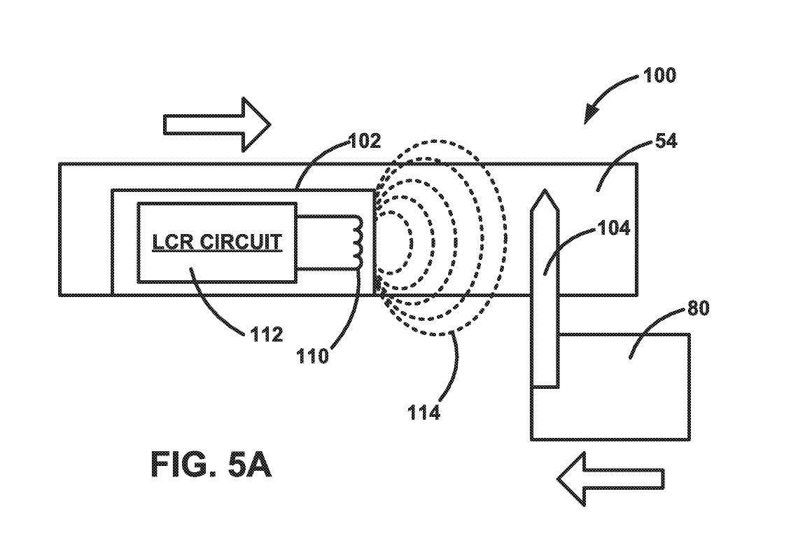

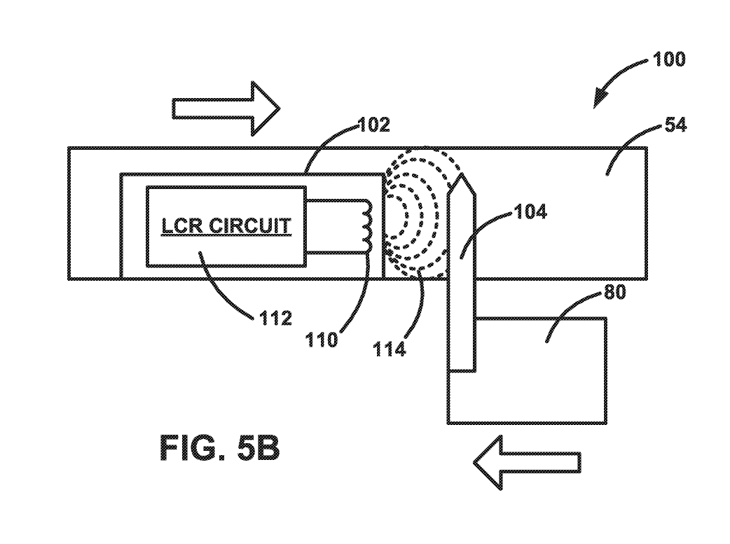

Referring to FIGS. 5A and 5B, in an example configuration of the brake pad wear sensing system 100, the sensor 102 is an inductive sensor. No physical contact between the sensor 102 and actuator 104 is required and both can be sealed or otherwise protected from the harsh environment (dirt, corrosion, moisture, temperature, etc.) of the braking system 50.

The sensor 102 of FIGS. 5A and 5B implements well-known conventional inductive sensor technology. The sensor 102 includes an inductive coil 110 and an LCR circuit 112 for exciting the coil and for detecting the actuator 104. The LCR circuit 112 includes an inductor-capacitor (LC) tank circuit and an oscillator for pumping the LC tank circuit. The inductor of the LC tank circuit is the coil 110, which produces a magnetic field 114 when the oscillator pumps the LC tank circuit. When the actuator 104 is distant from the sensor 102 (see FIG. 5A), the actuator has little or no affect on the field 14 produced by the sensor 102. As the actuator 104 is brought near the coil (see FIG. 5B), eddy currents form in the conductive metal of the actuator. The magnitude of the eddy currents varies as a function of the distance, the material, and the size of the actuator 104. The eddy currents form an opposing magnetic field that has the effect of increasing impedance in the LC tank circuit which the oscillation frequency, as the eddy currents increase.

The LCR circuit 112 is configured to measure this change in order to detect the actuator 104. The manner in which the sensor 102 detects the actuator 104 depends on the configuration of the LCR circuit 112. In one configuration, the LCR circuit 112 can be configured to detect the presence of the actuator, i.e., a yes/no switch that is toggled when the actuator 104 reaches a certain predetermined position relative to the sensor. In another configuration, the LCR circuit 112 can be configured to determine the actual distance to the actuator 104.

The brake pad wear sensor system 100 of the example configuration of FIGS. 5A and 5B can be configured as a worn pad detector (presence detector) or a pad wear detector (distance detector). In a worn pad detector configuration, the system 100 is configured to detect only when the brake pads have reached a predetermined amount of wear and to provide an indication that the pads are worn and require servicing. In a pad wear detector configuration, the system 100 is configured to detect the amount of the wear on the pads (e.g., % wear) and to provide an indication of that amount, such as the amount of wear on the pads or the useful life remaining in the pads. The system 100 can e configured to provide periodic warnings as the pads are worn, such as “50% remaining,” “25% remaining,” “10% remaining,” and “service required.” In operation, when the piston 80 and caliper 54 move in response to brake application, the position of the actuator 104 relative to the piston moves from the position illustrated in FIG. 5A to the position illustrated in FIG. 5B. As shown in the figures, this movement causes the magnetic field 114 to change and the LCR circuit 112 to respond, providing an output to the controller 106, which provides the appropriate indication to the vehicle operator.

### Capacitive Sensor Implementation

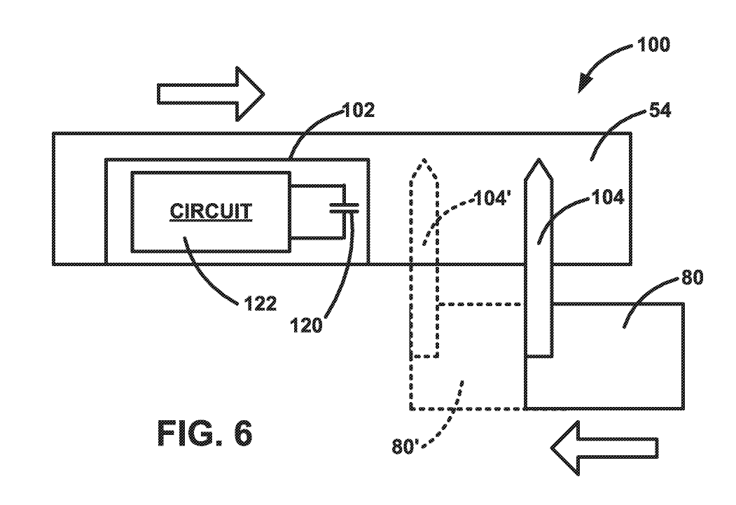

Referring to FIG. 6, in a capacitive sensing configuration, the sensing system 100 includes a capacitive sensor 102 that can detect an actuator 104, which can be metallic or nonmetallic. In this capacitive sensor implementation, a capacitor 120 comprising two conduction plates (at different potentials) are housed in the sensor 102 and positioned to operate like an open capacitor with air acting as an insulator. As known in the art, in the capacitive sensor 102, like inductive sensors, the capacitor 120 is linked to a control circuit 122 that includes an oscillator. As the actuator 104 enters the sensing zone the capacitance of the capacitor 120 increases, causing oscillator amplitude change, which triggers an output signal.

As known in the art, the similarity of the inductive sensor implementation (FIGS. 5A and 5B) and the capacitive sensor implementation (FIG. 6) is their oscillation frequency changes with respect to the proximity of the actuator 104. Thus, in operation, when the piston 80 and caliper 54 move in response to brake application, the position of the actuator 104 relative to the piston moves to the position illustrated in dashed lines at 104′ in FIG. 6. In one configuration, when the piston 80 and caliper 54 reach these positions, the sensor 102 could start to oscillate and output a brake pad worn signal. In yet another configuration, the sensor 102 frequency changes and outputs a % of brake pad remaining.

### Electrical Switch Implementation

In an electrical switching configuration, the actuator 104 can physically move a mechanical switch mechanism on the sensor 102 to make or break a circuit that is indicative of worn brake pads. Alternatively, the actuator 104 can include an electrically conductive element that engages contacts on the sensor 102 to complete a circuit that, when closed, indicates worn brake pads. As an additional alternative, the actuator 104 can include an electrically conductive element that engages contacts on the sensor 102, completing a circuit and providing a “pads OK” signal when brake pad wear is acceptable. When the brake pads are worn, the actuator 104 disengages from the contacts, breaking the circuit and providing a “replace pads” signal.

### Resistive Sensing Implementation

In a resistive sensing configuration, the actuator 104 can alter the resistance of a resistor element in response to changes in the thicknesses of the brake pads. Configuring the sensor 102 such that this variable resistor is part of a Wheatstone bridge circuit, the change in resistance, which is representative of the amount of wear in the pads, results in a change in the voltage measured across the bridge. One common bridge implementation of variable resistors involves strain gauges, which are elements whose resistance varies in response to mechanical strain. In one particular implementation, the sensor 102 can include a strain gauge implemented in a known bridge circuit configuration. The actuator 104 can be configured to make physical contact with the sensor 102 and place strain on the strain gauge when the brake pads reach a predetermined amount of wear. When the pads wear far enough that the actuator 104 causes a threshold amount of strain on the gauge, the sensor 102 can provide an output to the controller 106 that the controller can use to indicate to the vehicle operator that brake pad service is required.

### Optical Sensing Implementation

In an optical sensing configuration, the sensor 102 can comprise a light emitter (e.g., emitter diode), a light receiver (e.g., photodiode or phototransistor), and electronics for amplifying the receiver signal. The sensor 102 transmits light from the emitter to a reflector, which reflects the light back to be received by the receiver. In this configuration, the sensor 102 can detect when the light is blocked by the actuator 104. In this manner, the sensor system 100 can be configured such that the actuator 104 blocks the light beam when the pads reach the predetermined amount of wear.

### Magnetic Sensing Implementation

In a magnetic sensing configuration, the sensor 102 can comprise an element, such as a Hall sensor, that is sensitive to the presence of a magnetic field. In this configuration, the actuator 104 can include a permanent magnet. The sensor system 100 can be configured such that the magnetic field of the actuator 104 acts on the Hall sensor when the pads reach the predetermined amount of wear, causing the sensor 102 output to indicate that service is required.

Advantageously, the brake pad wear measuring system 100 measures the relative movement between the piston 80 and caliper 54 to infer the amount of wear on the brake pads. This has the effect of increasing the sensor resolution, which can be beneficial, especially where the system 100 measures % wear. Making the reasonable assumption that brake pads wear evenly between the inner and outer pad, any given amount of wear on a brake pad will result in a 2× change in the relative positions measured between the sensor 102 and actuator 104. Because the brake pad wear sensing system measures small changes in distance, i.e., brake pad wear, this 2× factor can improve the performance and reliability of the system 100.

From the above description of the invention, those skilled in the art will perceive improvements, changes and modifications. Such improvements, changes and modifications within the skill of the art are intended to be covered by the appended claims.

We claim:

1. A brake pad wear measuring system for use a floating caliper disc brake system comprising a piston supporting an inner brake pad and a floating caliper supporting an outer brake pad, wherein the piston and floating caliper move toward each other along a braking axis in response to application of the brake system so that the brake pads engage and apply a braking force to a brake rotor, the brake pad wear system comprising:
a sensor mounted on the floating caliper and movable with the floating caliper along the braking axis; and
an actuator mounted for movement with the piston along the braking axis;
wherein the sensor and actuator move toward each other in response to application of the disc brake system, wherein the distance that the sensor and actuator move toward each other in response to application of the disc brake system increases an amount that is equal to the total wear of the inner and outer brake pads, and wherein the sensor is responsive to the presence of the actuator to provide a signal indicative of brake pad wear.

2. The brake pad wear measuring system recited in claim 1, further comprising a controller that receives an output from the sensor and interprets the output to determine brake pad wear.

3. The brake pad wear measuring system recited in claim 2, wherein the controller determines the amount of brake pad wear in response to the output received from the sensor.

4. The brake pad wear measuring system recited in claim 2, wherein the controller determines that the brake pads require servicing in response to the output received from the sensor.

5. The brake pad wear system recited in claim 1, wherein the sensor comprises an inductive sensor and the actuator is a metallic member.

6. The brake pad wear system recited in claim 5, wherein the inductive sensor produces a magnetic field, wherein eddy currents are induced in the actuator in response to the sensor and actuator moving toward each other in response to application of the disc brake system.

7. The brake pad wear system recited in claim 5, wherein the output of the inductive sensor is proportional to the distance between the sensor and the actuator.

8. The brake pad wear system recited in claim 7, wherein the output of the inductive sensor is indicative of the amount of wear on the brake pads.

9. The brake pad wear system recited in claim 5, wherein the output of the inductive sensor indicates that the brake pads require servicing.

10. The brake pad wear system recited in claim 1, wherein the sensor comprises a capacitive sensor and the actuator is a metallic or nonmetallic member.

11. The brake pad wear system recited in claim 10, wherein the capacitive sensor responds to the presence of the actuator and produces an output that indicates the brake pads require servicing.

12. The brake pad wear system recited in claim 10, wherein the output of the capacitive sensor is proportional to the distance between the sensor and the actuator.

13. The brake pad wear system recited in claim 1, wherein the sensor comprises a mechanical switch, and the actuator actuates the switch in response to the application of the braking system, causing the sensor to produce an output that indicates the brake pads require servicing.

14. The brake pad wear system recited in claim 1, wherein the sensor comprises a resistive element whose resistance varies in response to movement of the actuator in response to the application of the braking system.

15. The brake pad wear system recited in claim 14, wherein the resistive element comprises a strain gauge arranged in a bridge circuit, and wherein the actuator engages the sensor to place strain on the gauge in response to the application of the braking system, causing the sensor to produce an output indicative of brake pad wear.

16. The brake pad wear system recited in claim 1, wherein the sensor comprises an optical sensor comprising a light emitter for transmitting a beam and a light receiver for receiving the beam, and wherein the actuator at least partially blocks the light beam in response to the application of the braking system, causing the sensor to produce an output indicative of brake pad wear.

17. The brake pad wear system recited in claim 1, wherein the sensor is comprises a magnetic sensor that is sensitive to the presence of a magnetic field, and the actuator comprises a permanent magnet, wherein the actuator produces a magnetic field that acts on the magnetic sensor in response to the application of the braking system, causing the sensor to produce an output indicative of brake pad wear.

18. A brake system comprising:
a floating caliper disc brake system comprising a piston supporting an inner brake pad and a floating caliper supporting an outer brake pad, wherein the piston and floating caliper move toward each other along a braking axis during braking so that the brake pads engage and apply a braking force to a brake rotor;
a sensor mounted on the floating caliper and movable with the caliper along the braking axis;
an actuator mounted for movement with the piston along the braking axis;
wherein the sensor and actuator move toward each other in response to application of the disc brake system, wherein the distance that the sensor and actuator move toward each other in response to application of the disc brake system increases an amount that is equal to the total wear of the inner and outer brake pads, and wherein the sensor is responsive to the presence of the actuator to provide a signal indicative of brake pad wear.
